(19) United States
(12) Patent Application Publication
(10) Pub. No.: US 2021/0222091 A1
(43) Pub. Date: Jul. 22, 2021

(54) SELF-PRESERVING LIQUID LAUNDRY DETERGENT FORMULATION

(71) Applicant: Dune Sciences, Inc., Eugene, OR (US)

(72) Inventors: David Alan Walla, Eugene, OR (US); John Martin Miller, Eugene, OR (US)

(73) Assignee: Dune Sciences, Inc., Eugene, OR (US)

(21) Appl. No.: 17/153,589

(22) Filed: Jan. 20, 2021

Related U.S. Application Data
(60) Provisional application No. 62/964,144, filed on Jan. 22, 2020.

(51) Int. Cl. C11D 3/43; C11D 3/00; C11D 3/04; C11D 3/20; C11D 1/14; C11D 1/83; C11D 3/22; C11D 3/386; C11D 11/00; C11D 17/00

(52) U.S. Cl. CPC C11D 3/43; C11D 17/0008; C11D 3/0047; C11D 3/04; C11D 3/2013; C11D 3/2065; C11D 3/2079; C11D 3/2082; C11D 3/2086; C11D 1/143; C11D 1/83; C11D 3/222; C11D 3/38618; C11D 3/38636; C11D 3/38645; C11D 11/0017; C11D 3/0036

(57) ABSTRACT

Embodiments provide for an eco-friendly and non-toxic self-preserving liquid laundry detergent composition incorporating a blend of ingredients, at least some of which are multi-functional, thereby promoting both anti-stain and anti-odor functions while also contributing to composition preservation.

### CROSS-REFERENCE TO RELATED APPLICATION

This application claims the priority benefit of the earlier filing date of U.S. Provisional Application No. 62/964,144, filed Jan. 22, 2020, which is hereby incorporated herein by reference in its entirety.

### TECHNICAL FIELD

Embodiments herein relate to cleaning product compositions, and more specifically, to self-preserving detergent compositions that include eco-friendly multifunctional ingredients.

### BACKGROUND

Consumers are becoming increasingly cautious in terms of the use of cleaning products that include ingredient(s) with the potential for eco-toxicity and/or toxicity to human and other animal species. Accordingly, it can be challenging for formulators of cleaning products to keep pace with public demand for cleaning products with reduced toxicity and low potential for harm to the environment from both manufacturing and finished goods perspectives. For example, many laundry detergents incorporate preservatives including but not limited to quaternary ammonium compounds, benzoates, parabens, formaldehyde donors, isothiazolinones, and the like, which are increasingly of concern to consumers due to their potential human and ecological toxicity. Hence, there exists a need to develop cleaning product formulations, for example laundry detergent formulations, that can address these consumer demands and reduce the toxicity burden on both users of the products and the environment.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIGS. 1A-1E depict example images of various microorganisms used for antimicrobial effectiveness testing of liquid laundry detergent (LLD) formulations of the present disclosure.

FIG. 2 is a graph illustrating colony forming units (CFU) per gram of a first test formulation (Free and Clear LLD) of the present disclosure, for a variety of microorganisms, at time zero, day 14, and day 28 post-inoculation.

FIG. 3 is a graph illustrating colony forming units (CFU) per gram of a second test formulation (Lavender LLD) of the present disclosure, for a variety of microorganisms, at time zero, day 14, and day 28 post-inoculation.

FIG. 4 is a graph illustrating colony forming units (CFU) per gram of a third test formulation (Lavender LLD) of the present disclosure, for a variety of microorganisms, at time zero, day 14, and day 28 post-inoculation.

FIG. 5 is a graph illustrating colony forming units (CFU) per gram of a fourth formulation (Lavender LLD) of the present disclosure, for a variety of microorganisms, at time zero, day 14, and day 28 post-inoculation.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense.

Various operations may be described as multiple discrete operations in turn, in a manner that may be helpful in understanding embodiments; however, the order of description should not be construed to imply that these operations are order-dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

As consumers become more critical of ingredients contained in cleaning products, manufacturers are facing ever-increasing requirements for ingredient disclosure. However, ingredient disclosure exposes formulation manufacturers to increasing scrutiny of the ingredients used in formulating their cleaning products. Many formulators of cleaning products rely heavily on isothiazolinone-based preservatives which can elicit allergic reactions to the point that methylisothiazolinone was named the contact allergen of the year in 2013 by the American Contact Dermatitis Society. At least one website exists that is dedicated to providing consumers with resources related to isothiazolinone free products. At least one shopping store has banned the use of methylchloroisothiazolinone from cleaning products sold on its shelves. Formaldehyde and formaldehyde donor preservatives are prohibited by the EPA safer choice program and at least one store has excluded sales of items containing such preservatives. Given the above, there is a need for cleaning product formulations that do not rely on high use levels of toxic or otherwise negatively perceived synthetic microbicidal agents, but which still provide effective control of microorganisms in a manner that is quick and long lasting.

I. Overview of Several Embodiments

The present disclosure in one aspect relates to a cleaning product composition comprising a solvent, and one or more agents, each of the one or more agents operable to impart a particular property to the cleaning product composition. In an example, the cleaning product composition includes a combination of a water activity of less than 0.7, an alkaline or acidic pH (e.g., >7.1, or <6.9), an ionic strength corresponding to a conductivity of greater than 30 mS/cm, and a high osmolarity and tonicity, where high osmolarity and tonicity refers to a capability of the composition to cause a chemical potential imbalance across a microbial cell membrane sufficient to prevent or reduce microbial cell proliferation and/or survival.

In an embodiment the solvent comprises 20-30 wt. % of the composition. In other examples, the solvent comprises less than 50 wt. % of the composition. In some examples, the solvent is water. In other examples, the solvent is water plus an organic liquid. In still other examples, the solvent is one or more organic liquids without added water.

In an embodiment, the one or more agents may comprise one or more dirt lifting and removal agents comprising 15-50 wt. % of the composition. In examples, the one or more dirt lifting and removal agents include at least one of decyl glucoside, lauryl glucoside, sodium olefin sulfonate, distilled tall oil fatty acid, and lauric acid.

In an embodiment, the one or more agents may additionally or alternatively comprise one or more composition stabilizer agents comprising 0.1-15 wt. % of the composition. In examples, the one or more composition stabilizer agents are selected from an alkali metal and/or alkaline earth-metal compound (e.g., calcium chloride) included at between 0.005 and 0.02%, for example, and glycerol.

In an embodiment, the one or more agents may additionally or alternatively comprise one or more mineral deposit preventative agents comprising 0.1-15 wt. % of the composition. In example, the one or more mineral deposit preventative agents are selected from conjugate base(s) of one or more organic acids (e.g., sodium citrate dihydrate) and a methylglycinediacetic acid salt (e.g., sodium).

In an embodiment, the one or more agents may additionally or alternatively comprise one or more pH control agents comprising 0.1-5 wt. % of the composition. In examples, the one or more pH control agents may be selected from sodium and/or potassium carbonate and sodium and/or potassium hydroxide. In additional or alternative examples, the pH control agents may include but are not limited to fatty acids (e.g., lauric acid, oleic acid, tall oil fatty acids) citric acid, lactic acid, glycolic acid, mandelic acid, malic acid, tartaric acid, and the like.

In an embodiment, the one or more agents may additionally or alternatively comprise one or more odorant agents and/or one or more stain remover agents comprising 0.1-20 wt. % of the composition. In examples, the one or more odorant agents may include but are not limited to essential oils (e.g., citral, linalool, linalyl acetate, limonene, thujone, myrcene, etc.). The one or more stain remover agents may be selected from one or more of protease, phosphodiesterase, amylase, pectate lyase, cellulase, and mannanase. It may be understood that stain remover agents may in some examples function additionally or alternatively as de-odorants.

In an embodiment, the one or more agents may additionally or alternatively comprise one or more grease removal agents comprising 0.1-15 wt. % of the composition. In examples, the one or more grease removal agents comprise at least one of di isopropylidene glycerol, 1,3 propane diol, and ethanol.

In an embodiment, the one or more agents may additionally or alternatively comprise one or more anti-redeposition agents comprising 0.1-8 wt. % of the composition. In examples, the one or more anti-redeposition agents is a high molecular weight polymer of 50,000 Daltons or greater (e.g., carboxymethyl cellulose, xanthan gum, corn starch, and/or carboxymethylinulin).

In an embodiment, the composition may further comprise an essential oil.

In embodiments, the composition is free of isothiazolinones, quaternary ammonium compounds, benzoates, parabens, and formaldehyde donors.

In some embodiments, the composition may further comprise an effective amount of aspen bark extract as a preservative.

In embodiments, the composition may be comprised of at least 85% bio-based carbon.

In embodiments, the cleaning product composition comprises one or more of a stain removal composition, a surface cleaner composition, and a laundry detergent composition.

Another aspect of the present disclosure relates to a self-preserving liquid laundry detergent composition. The self-preserving liquid laundry detergent may comprise a solvent at 20-50 wt. % of the composition; one or more anionic surfactants comprising 1-20 wt. % of the composition; one or more nonionic surfactants comprising 5-25 wt. % of the composition; one or more enzymes comprising 0.1-5 wt. % of the composition; one or more minerals comprising 0.01-5 wt. % of the composition; conjugate base(s) of one or more organic acids comprising 0.1-5 wt. % of the composition; one or more biodegradable polymers comprising 0.1-5 wt. % of the composition; and wherein the composition is comprised of at least 85% bio-based carbon and is free from isothiazolinones, quaternary ammonium compounds, benzoates, parabens, and formaldehyde donors.

In an embodiment of the laundry detergent composition, the one or more anionic surfactants may include a first component with a high oleic acid and/or linoleic acid content, and a second component with a high lauric acid content. In examples, a weight ratio of the first component to the second component is between 1:1 and 5:1, respectively. In some examples, the weight ratio of the first component to the second component is between the 3:1 and 4:1, respectively. In some examples, the one or more anionic surfactants may further comprise a third component that is a synthetic anionic surfactant. In such an example, a weight ratio of the third component to the first component may be between 1:1 and 4:1, respectively. In some examples, the weight ration of the third component to the first component may be between 1:1 and 1.5:1, respectively.

In an embodiment of the laundry detergent composition, the one or more nonionic surfactants may include one or more alkyl poly glucosides. In examples, the one or more alkyl poly glucosides may include decyl glucoside and/or lauryl glucoside. In some examples, a weight ratio of the decyl glucoside to the lauryl glucoside is between 1.1:1 and 2:1, respectively. In examples, the weight ratio of the decyl glucoside to the lauryl glucoside is between 1.5:1 and 2:1, respectively.

In an embodiment of the laundry detergent composition, the one or more enzymes may be selected from protease, amylase, pectate lyase, cellulase, phosphodiesterase, and mannanase.

In an embodiment of the laundry detergent composition, the conjugate base(s) of one or more organic acids may be selected from citrate, lactate, glycolate, mandelate, malate, and tartrate.

In an embodiment of the laundry detergent composition, the one or more biodegradable polymers may be selected from carboxymethyl cellulose, xanthan gum, corn starch, and carboxymethylinulin.

In an embodiment of the laundry detergent composition, the solvent is water. In another embodiment of the laundry detergent composition, the solvent is water and one or more organic liquids. In yet another embodiment of the laundry detergent composition, the solvent is one or more organic liquids without added water. Examples of the one or more organic liquid(s) may include but are not limited to glycerol, polyethylene glycol, 1,3 propanediol, isopropanol, ethanol, methanol, butanol, dimethoxymethane, dioxolane, and Solketal.

In an embodiment of the laundry detergent composition, the composition may comprise one or more of the following features: water activity of less than 0.7; an alkaline or acidic pH (e.g., >7.1 or <6.9); an ionic strength corresponding to a conductivity >30 mS/cm; and a high osmolarity (>500 mOS/L) and tonicity, where high osmolarity and tonicity refers to a capability of the composition to cause a chemical potential imbalance across a microbial cell membrane sufficient to prevent or reduce microbial cell proliferation and/or survival.

In another aspect, the present disclosure relates to a liquid laundry detergent composition. The liquid laundry detergent may comprise a solvent comprising less than 40 wt. % of the composition; a plurality of anionic surfactants comprising 5-20 wt. % of the composition, the plurality of anionic surfactants including tall oil fatty acid, lauric acid, and a synthetic C14-C16 olefin sulfonate, where a weight ratio of the tall oil fatty acid to the lauric acid is between 1:1 and 4:1 (e.g., 3.5:1), and where a weight ratio of the synthetic C14-C16 olefin sulfonate to tall oil fatty acid is between 1:1 and 3:1 (e.g., 1.3:1); a plurality of nonionic surfactants comprising 5-25 wt. % (e.g., 20-25%) of the composition, the plurality of nonionic surfactants comprising decyl glucoside and lauryl glucoside at a weight ratio of the decyl glucoside to the lauryl glucoside between 1:1 and 4:1 (e.g., between 1:5 and 2:1); one or more carbonate salts at 0.5-5.0 wt. % of the composition; a blend of two or more salts selected from citrate, lactate, glycolate, mandelate, malate, and tartrate, the blend comprising between 1-6 wt. % (e.g., 2-5%) of the composition; one or more biodegradable chelating agents at 1-6 wt. % of the composition; one or more biodegradable polymers at 1-6 wt. % (e.g., 1.5-3%) of the composition; and a blend of two or more enzymes selected from protease, amylase, pectate lyase, and cellulase, the blend at 1-6 wt. % (e.g., 3-5%) of the composition.

In an embodiment of the liquid laundry detergent composition, the one or more biodegradable polymers may be selected from carboxymethyl cellulose, xantham gum, corn starch, and carboxymethyl inulin. In examples, the one or more biodegradable polymers is selected from carboxymethyl inulin, carboxymethyl cellulose, xanthan gum, corn starch or other similar high molecular weight polymers.

In an embodiment of the liquid laundry detergent composition, the one or more biological chelating agents may be selected from sodium gluconate and methylglycinediacetic acid sodium salt.

In an embodiment of the liquid laundry detergent composition, the solvent is water. In another embodiment, the solvent comprises water and one or more other organic liquids. In yet another embodiment, the solvent is one or more organic liquid(s). In examples, the one or more organic liquids may comprise alcohols or acetals, including but not limited to, for example, glycerol, polyethylene glycol, 1,3 propanediol, isopropanol, ethanol, methanol, butanol, dimethoxymethane, dioxolane, and Solketal. Where included in addition to water, the one or more organic liquids may be present at 1-15%, for example 2-14%, 3-13%, 4-12%, 5-11%, 6-10%, 7-9%, and any percentage encompassed by these ranges.

In an embodiment of the liquid laundry detergent composition, the composition may further comprise one or more of citral, linalool, linalyl acetate, limonene, thujone, and myrcene.

In an embodiment of the liquid laundry detergent composition, the weight ratio of the decyl glucoside to the lauryl glucoside may be 1.77:1.

In some embodiments of the liquid laundry detergent composition, the composition may further comprise an effective amount of aspen bark extract.

In an embodiment of the liquid laundry detergent composition, the composition may comprise one or more of the following features: water activity of less than 0.7; an alkaline or acidic pH (e.g., >7.1 or <6.9); an ionic strength corresponding to a conductivity >30 mS/cm; and a high osmolarity (>500 mOS/L) and tonicity, where high osmolarity and tonicity refers to a capability of the composition to cause a chemical potential imbalance across a microbial cell membrane sufficient to prevent or reduce microbial cell proliferation and/or survival.

In yet another aspect, the present disclosure relates to a liquid laundry detergent composition, comprising a solvent comprising 20-30 wt. % of the composition; one or more dirt lifting and removal agents comprising 38-42 wt. % of the composition; one or more composition stabilizers comprising 5-7 wt. % of the composition; one or more mineral deposit preventative agents comprising 5-7 wt. % of the composition; one or more pH control agents comprising 2.5-4.5 wt. % of the composition; one or more odorant and/or stain remover agents comprising 3-5 wt. % of the composition; one or more grease removal agents comprising 8-10 wt. % of the composition; and one or more anti-redeposition agents comprising 2-4 wt. % of the composition.

In some embodiments, the composition further includes an effective amount of aspen bark extract which functions as a natural preservative. With or without the aspen bark extract, the composition may be comprised of at least 85% bio-based carbon, and may be free of isothiazolinones, quaternary ammonium compounds, benzoates, parabens, and formaldehyde donors.

In embodiments, the one or more dirt lifting and removal agents are selected from decyl glucoside, lauryl glucoside, sodium olefin sulfonate, distilled tall oil fatty acid, and lauric acid.

In embodiments, the one or more formula stabilizers are selected from calcium chloride and glycerol.

In embodiments, the one or more mineral deposit preventative agents are selected from sodium citrate dihydrate and methylglycinediacetic acid sodium salt.

In embodiments, the one or more pH control agents are selected from sodium carbonate and potassium hydroxide.

In embodiments, the one or more odorant and/or stain remover agents further comprise one or more of protease, amylase, pectate lyase, cellulase, phosphodiesterase, and mannanase.

In embodiments, the one or more grease removal agents are selected from di isopropylidene glycerol, 1,3 propane diol, and ethanol.

In embodiments, the one or more anti-redeposition agents includes at least carboxymethylinulin.

In some embodiments, the composition further comprises an essential oil comprised of one or more of citral, linalool, linalyl acetate, limonene, thujone, and myrcene.

These and other aspects of the present invention will become more apparent upon reading the following description.

II. Terms

As used herein, the term “liquid” includes liquid, paste, wax, gel, and mixtures thereof including liquid compositions packaged in water-soluble capsules or pouches. The liquid composition may in some examples comprise one or more solids suspended therein, including powders or agglomerates, which may provide a technical benefit and/or an aesthetic effect.

As used herein, all concentrations and ratios are on a weight basis unless otherwise specified. All temperatures herein are in degrees Celsius (° C.) unless otherwise specified.

As used herein, the term “osmolarity”, or “osmotic concentration” includes the concentration of a solution expressed as the total number of solute particles per liter. As used herein, the term “tonicity” is defined as a measure of the effective osmotic pressure gradient cause by an imbalance of osmolarity from inside a cell to outside a cell, or in other words, and osmolarity imbalance across a cell membrane. Whereas osmolarity includes ionic species that can cross cell membrane walls, tonicity is influenced only by solutes that cannot cross the cell membrane, as only these exert an effective osmotic pressure.

When a cell is immersed in a hypertonic solution (e.g., greater solute concentration outside the cell than inside), osmotic pressure tends to force water to flow out of the cell in order to balance the concentrations of the solutes on either side of the cell membrane. Both osmolarity and tonicity are closely related to the water concentration and activity in the laundry detergent compositions of the present disclosure, but are also influenced by the kinds of particles in solution through colligative properties (e.g., those properties of solutions that depend on the ratio of the number of solute particles to the number of solvent particles in a solution, and not on the nature of the chemical species present). Conductivity (a measure of ionic strength) of a composition may be understood to contribute to high tonicity with regard to compositions of the present disclosure. For example, compositions having high conductivity as herein disclosed may have conductivity at least 15 mS/cm (e.g., greater than 20 mS/cm, or greater than 25 mS/cm, or greater than 30 mS/cm, or greater than 35 mS/cm, or greater than 40 mS/cm, or greater than 45 mS/cm, or greater than 50 mS/cm.

Interactions of the solute particles with the solvent (water in the case of the liquid laundry detergents of the present disclosure) and microbial cell wall membranes through electrostatic forces or hydrogen bonding, for example, influence the osmotic behavior of the solution when in contact with microbial species. Microbial species may comprise, for example, bacteria and/or fungi and/or viruses. The chemical potential imbalance resulting from high tonicity and high osmolarity can prevent microbial cells from normal function and proliferation, and can result in cell lysis. Accordingly, discussed herein, the phrase “high osmolarity and tonicity” refers to a solution that causes a chemical potential imbalance across a cell membrane (e.g., microbial cell membrane) sufficient to prevent or reduce microbial cells from normal function and proliferation and which can result in cell lysis. In examples, compositions of the present disclosure may include at least one, but preferably two or more different solutes (e.g., molecules, ingredients, compounds, etc.) with an ability to directly interact with and, in some examples advantageously disrupt, a microbial cell membrane. Solutes may include but are not limited to surfactants, hydrotopes (compounds that solubilize hydrophobic compounds in aqueous solutions by means other than micellar solubilization), and the like.

In examples herein discussed, high osmolarity includes compositions with an osmolarity of at least 0.5 osmoles (Osm)/L. For example, osmolarity of a composition of the present disclosure may be between 0.5 and 1.0 Osm/L, such as 0.6 Osm/L, 0.75 Osm/L, 0.8 Osm/L, 0.9 Osm/L, etc. In some examples, osmolarity of a composition of the present disclosure may be between 1.0 and 4 Osm/L, such as 2.25 Osm/L, 2.5 Osm/L, 2.75 Osm/L, 3.0 Osm/L, 3.25 Osm/L, 3.5 Osm/L, 3.75 Osm/L, etc. In some examples, osmolarity of a composition of the present disclosure may even be higher than 4 Osm/L. It may be understood that the osmolarity upper limit with regard to compositions of the present disclosure may be defined by a solubility limit of the solutes in the solvent component of a particular composition.

Efficacy in terms of osmolarity with respect to preventing or reducing microbial cells from normal function and proliferation may be understood to increase as osmolarity increases. However, in some applications where a reduced osmolarity is desirable or required for a particular composition, efficacy may be maintained at the lower osmolarities provided a threshold osmotic concentration value is maintained. The threshold osmotic concentration value may be at least 0.5 Osm/L for most applications discussed herein. However, it is within the scope of this disclosure that a composition may comprise osmolarity less than 0.5 Osm/L, without departing from the scope of this disclosure. The threshold osmotic concentration value may be a value which induces a threshold osmotic pressure imbalance across a microbial cell wall.

The presence of more solutes (e.g., greater than 1 solute) may be advantageous in overcoming or overwhelming defense mechanisms inherent to particular microbial cells. In other words, in examples, compositions of the present disclosure may have an abundance of, and in some examples a variety of, solutes to ensure that a sufficient amount is present to induce a high osmotic pressure across cell membranes, which may contribute to microbial cell lysis.

Efficacy in terms of osmolarity with respect to preventing or reducing microbial cells from normal function and proliferation may be independent of a particular identity or nature of individual compounds of the solute component of compositions of the present disclosure. That said, smaller molecules may be more efficacious than larger molecules due to solvent capacity (e.g., the ability to, in general, include a greater number of smaller molecules in a given amount of solvent component as compared to an equimolar amount of larger molecules), and relative ease at which the smaller molecules can cross cell membranes.

Thus, discussed herein, any number of solutes can be used to increase osmolarity of compositions of the present disclosure, to increase a differential osmotic pressure across a microbial cell wall membrane. In one example, the solutes are ionic compounds (e.g., salts).

Wherein one or more organic acids or bases are used in a composition of the present disclosure, one example approach to increasing osmolarity may involve inclusion of salt(s) of one or more of the acid(s) or base(s) and/or one or more other organic acids. For example, where a particular composition includes an acid, a many fold excess (e.g., 3×, 4×, 5×, 6×, 7×, 8×, 9×, 10×, or even higher) of one or more salts of that acid can also be included. The identity may not be critical, and can include but is not limited to ammonium ions and alkali metals, as examples. Where a polyacid is used, all or fewer than all of the hydrogen atoms of the carboxyl groups can be replaced with cationic atoms or groups, which can be the same or which can be different. For example, mono, di- and trisodium citrate all constitute buffer precursors useful for compositions of the present disclosure. Because trisodium citrate has three available basic sites, a theoretical buffering capacity may be up to 50% greater than that of disodium citrate (which has two such sites), and up to 200% greater than that of monosodium citrate (which has only one such site). Thus, it may be understood that polyacids are within the scope of this disclosure.

As used herein, the term “water activity” includes the partial vapor pressure of water in a substance divided by the standard state partial vapor pressure of free water. Water activity influences the viability of bacteria and mold, as examples. Pure distilled water has a water activity of exactly 1. This number increases with increasing temperature. Water activity can also decrease via structuring or confining water mobility through interactions with other chemical species. As water activity decreases (due to the organization/confinement of the water molecule mobility), microbial cells cannot uptake water due to osmotic stress and may become dormant. Hence, the ability to support microbial proliferation is reduced as water activity decreases. For example, bacteria may require water activity of at least 0.91, and fungi may require water activity of at least 0.7 to proliferate. As used herein, the term “low water activity” refers to water activity less than 1, or less than 0.8, or even in some examples less than 0.7. It may be understood that in a system with no water, water activity is zero. Even in compositions of the present disclosure that do not include added water (e.g., solvent is an organic liquid), there will be some amount of water present due to its association with one or more other ingredients (e.g., surfactants) and/or due to the composition absorbing water moisture from air.

As used herein, the term “ionic strength” refers to a measure of the concentration of ions in a particular solution (e.g., liquid laundry detergent composition). Ionic compounds, when dissolved in water, dissociate into ions that, in turn, influence osmolarity and ion transport in and out of cells. Increases in ionic strength reduces the barrier for cell membrane disruption via osmotic pressure differential. This property can help to facilitate the disruption of microbial cell function and proliferation. As used herein, the term “high ionic strength” refers to composition having a conductivity of at least 15 mS/cm, more preferably at least 30 mS/cm.

As used herein, the term “effective amount” refers to an amount of an agent or other property (e.g., osmolarity, tonicity, ionic strength, water activity) sufficient to generate a desired response (e.g., outcome). As an example, an effective amount is corresponds to an amount of an agent or agents sufficient to reduce or inhibit microbial growth and/or survival in the laundry detergent compositions of the present disclosure. As an additional or alternative example, an effective amount can refer to particular osmolarity and/or tonicity sufficient to reduce or inhibit microbial growth and/or survival. As an additional or alternative example, an effective amount can refer to an ionic strength sufficient to reduce or inhibit microbial growth and/or survival. In yet another additional or alternative example, an effective amount can refer to a water activity sufficient to reduce or inhibit microbial growth and/or survival. In still other additional or alternative examples, an effective amount can refer to an amount of a natural preservative (e.g., aspen bark extract) sufficient to impart a desired amount of preservative quality on, for example, a detergent composition of the present disclosure.

In other examples, an effective amount can refer to an amount of an agent or agents sufficient to generate a desired response including but not limited to lifting and removing dirt from a fabric, removing odor and/or stains from a fabric, removing grease from a fabric, inhibiting stains from redepositing on a fabric during, for example, a wash and rinse cycle of a laundering operation, and the like.

It may be understood that microbial growth and/or survival need not be 100% inhibited in order for a particular agent or property to be considered effective. Along similar lines, not every molecule of dirt, odor, stain, grease, and the like need to be removed from fabric in order for a particular agent or property to be considered effective. Instead, the effective amount as herein disclosed simply need generate the desired outcome to be considered effective.

As used herein, “builders” refer to chemical compounds that are added to a detergent product to improve its cleaning properties. A measure of cleaning effectiveness may include the net amount of soil removed from a fabric, specifically the total soil removed minus the amount that is redeposited. Hence, materials that serve as builders as herein disclosed refer to materials that perform one or both (preferably both) of 1) increasing the removal of soil, and 2) preventing or minimizing its redeposition.

As used herein, a “water softening agent” refers to an agent that is at least capable of reducing a concentration of multivalent cations (e.g., Ca²⁺, Mg²⁺) in a liquid material (e.g., water).

As used herein, the term “essential oil” refers to a natural oil obtained, for example, by distillation, and having the characteristic fragrance of the plant or other source from which it was extracted. In addition to imparting a characteristic fragrance to a cleaning product composition (e.g., liquid laundry detergent) of the present disclosure, essential oils and components thereof may impart antimicrobial properties to the composition. Examples of essential oils may include but are not limited to lemongrass oil, perilla oil, tea tree oil, coriander oil, thyme (wild) oil, thyme (geraniol) oil, peppermint oil, lavender oil, rosemary oil, eucalyptus oil, citron oil, and the like. Essential oils, as referred to herein, may be understood to comprise blends of essential oils, for example a blend of one or more of lemongrass oil, perilla oil, tea tree oil, coriander oil, thyme (wild) oil, thyme (geraniol) oil, peppermint oil, lavender oil, rosemary oil, eucalyptus oil, citron oil, and the like. Also within the scope of this disclosure are fractionated components of essential oils. For example, an essential oil may include any number of compounds suitable for use in the compositions of the present disclosure. As one example, fractional distillation (e.g., vacuum fractional distillation) may be used to obtain more concentrated and/or more purified solutions of a particular compound of an essential oil, and it is within the scope of this disclosure to utilize such fractions in the compositions of the present disclosure.

As used herein, the term “self-preserving” refers to a composition which includes any number of ingredients that are multi-functional in nature and which may contribute to preservative properties of the composition but which are not included solely because of a preservative function. For example, a multi-functional ingredient may comprise a compound that acts as one or more of a dirt lifting and removal agent, but also contributes to increased osmolarity and/or tonicity, which can act to reduce or prevent microbial proliferation and/or survival. As another example, a carbonate salt (e.g., sodium carbonate) may serve as a pH control agent, and may additionally function as a builder and/or a water softener and/or may act to metabolically inhibit contaminating microbes (e.g., via dissolved CO₂) in a composition of the present disclosure. As yet another example, ethanol may serve as a grease removal agent, but ethanol may additionally may contribute to protein degradation/aggregation, which may be useful in terms of reducing or preventing microbial contamination. Self-preserving compositions of the present disclosure may be understood to be free from preservatives including but not limited to, for example, isothiazolinones, quaternary ammonium compounds, benzoates, parabens, and formaldehyde donors, to name a few.

III. Compositions

Cleaning Product Formulations

As used herein, the phrase “cleaning product formulation” broadly encompasses compositions and formulations designed for a wide variety of cleaning operations (e.g., cleaning products for appliances, dishware, vehicle exterior and/or interior, windows, flooring, laundering operations, and the like). In one embodiment, the cleaning product formulations are designed for cleaning or treating fabrics or other similarly flexible materials comprised of a network of natural, artificial and/or synthetic fibers, including but not limited to cotton, wool, linen, silk, nylon, polyester, acrylic, or blends thereof. The cleaning product formulations as herein disclosed may thus comprise laundry detergent compositions. It is within the scope of this disclosure that the laundry detergent compositions be used for laundry pre-wash, laundry pre-treat, laundry additives, spray products, wash additives, liquid hand laundry washing compositions, and other suitable forms that may be apparent to one skilled in the art in view of the present disclosure. It is within the scope of this disclosure that the laundry detergent compositions disclosed herein be used as pre-laundering treatment and/or used during the wash and/or rinse cycle of a laundering operation. In examples, the laundry detergent compositions herein disclosed comprise a liquid laundry detergent and can be a fully formulated laundry detergent product. Liquid compositions contained in encapsulated and/or unitized dose products are included.

The cleaning product formulations of the present disclosure have a pH of 7.1 or greater, for example between 8-13, or 8.5-13, or 8.5-9, or 9-9.5, or 9.5-10, or 10-10.5, or 10.5-11, or 11-11.5, or 11.5-12, or 12-12.5, or 12.5-13. In examples, the pH is between 8.5-10, for example pH 9.0. However, in other examples, cleaning product formulations of the present disclosure may have a pH of 6.9 or lesser, for example between 3.5-6.9, such as 4, 4.5, 5, 5.5, 6, 6.5, etc. In some examples, a cleaning product formulation with a neutral pH (e.g., pH 7) is within the scope of this disclosure.

In embodiments, the cleaning product formulations (e.g., liquid laundry detergent composition) disclosed herein are provided as single-phase liquid products that are stable, for example that exhibit no visible phase separation when placed at 5° C., 22° C., and 40° C., or any temperature between, respectively, and under atmospheric pressure for at least 24 hours or more.

In embodiments, the cleaning product formulations herein disclosed may provide one or more of the following advantageous features. For example, they may be substantially resistant to microbial spoilage. Specifically, a composition of the present disclosure may resist spoilage (deterioration of the composition by the contaminant microbe) for a period of at least 12 months, or at least 24 months, when stored at 30° C. or lower, or 25° C. or lower, or 20° C. or lower. In some examples, a composition of the present disclosure may be free from any ingredients that have the sole purpose of preservation of the composition. The compositions herein disclosed are free of isothiazolinones, quaternary ammonium compounds, benzoates, parabens, formaldehyde donors, and other similar toxic and/or potentially harmful preservatives. Furthermore, in a case where a natural preservative is included, the natural preservative may be multi-functional. Specifically, the sole purpose of the natural preservative may not be preservation, but the natural preservative may additionally in some examples contribute to, for example, high osmolarity and/or high tonicity, antimicrobial properties, and the like.

The compositions of the present disclosure may exhibit little to no irritation to skin, when used in diluted and/or non-diluted form. For example, the compositions of the present disclosure may not cause perceptible itch, rash, or other indications of skin irritation when used in their diluted and/or non-diluted form. If any itch, rash, or other indication of skin irritation occurs, it may be understood that the irritation may be of a minor level, assuming the absence of a particular allergic reaction to one or more ingredients in the composition.

The compositions of the present disclosure may be comprised of at least 80% bio-based carbon, preferably at least 85%, and in some examples 90-95% or higher. The compositions may use ingredients listed on the United States Environmental Protection Agency (EPA) Safer Chemical Ingredient List. The Safer Chemical Ingredients List is a list of chemical ingredients, arranged by functional-use class, that the Safer Choice Program has evaluated and determined to be safer than traditional chemical ingredients.

The compositions of the present disclosure may exhibit low ecotoxicity. Low ecotoxicity as used herein refers to having little to no ecotoxicity on the basis of established thresholds, which provide a means of measuring the ecotoxicity impact of the compositions of the present disclosure.

The compositions of the present disclosure may exhibit little to no odor in some examples (in diluted or even undiluted form). For example, little to no odor may comprise an amount of odor that would not be deemed offensive to a majority of a population of test subjects. In examples where a particular odor is desired (e.g., lavender, lemongrass, etc.), the odor may be gentle and not overwhelming (in diluted and/or undiluted form). Furthermore, the compositions of the present disclosure may be capable of significantly reducing an amount of body odor molecules present on fabric, for example to below determined threshold levels. In terms of the odor of the detergent compositions of the present disclosure (in diluted and/or non-diluted form), and the ability to reduce body odor molecules on fabric, in examples an olfactometer may be used to gauge odor detection thresholds.

The detergent compositions of the present disclosure may comprise compositions having one or more of the following features low water activity; high osmolarity and tonicity; high ionic strength; and an alkaline or acidic pH (or in some examples neutral pH). These qualities may be advantageous in terms of facilitating anti-microbial nature of the detergent compositions herein disclosed. Specifically, it is herein recognized that some combination of these features can impart on the compositions of the present disclosure a self-preserving nature, such that the composition may be free from any ingredients whose sole purpose is preservation of the composition. It may be understood that such compositions may contain ingredients that contribute to composition preservation, for example via contributing to one or more of the features mentioned above (low water activity; high osmolarity and tonicity; high ionic strength; and an alkaline pH, for example). However, such ingredients that contribute in such a manner to composition preservation may additionally impart other properties upon the composition (e.g., dirt lifting and removal properties, composition stabilizing properties, mineral deposit preventative properties, pH control properties, odorant and/or stain removal properties, grease removing properties, anti-redeposition properties, and the like). In other words, the ingredients of the compounds of the present disclosure may comprise multi-functional ingredients, whose sole purpose may not comprise composition preservation.

With regard to the features that impart self-preservation on the compositions of the present disclosure (e.g., low water activity; high osmolarity and tonicity; high ionic strength; and an alkaline pH), in some examples just one of the features is included in a composition, in another example just two of the features is included in a composition, in another example three of the features is included in a composition, and in yet another example all four of the features is included in a composition. In some examples, the more features that are included the greater the self-preserving nature of the composition.

Solvents

The compositions of the present disclosure may include water at less than 50%, preferably less than 48%, and in some examples less than 40%, or even less than 30%, for example between 25-30%. In examples, the water may have a resistivity of 5 MO or greater. In examples, low water content may serve to reduce total water activity. Low conductivity water may also provide flexibility to control osmolarity and ion specificity. In addition, low water content with the resistivity of 5 MO or greater can reduce opportunity for the presence of impurities including but not limited to microbes. That said, it is within the scope of this disclosure that the water used in the compositions of the present disclosure need not be distilled, deionized, or the like, however such treatments are within the scope of this disclosure. It may be understood that the water used in the compositions of the present disclosure may preferably be free of bacteria without advance treatment to render the water free of bacteria.

Water may be employed in the solvent component of compositions of the present disclosure due to its high solute holding capability (thus enabling higher osmolarity compositions), wetting properties, biocompatibility, environmental friendliness, and low cost.

In some examples, the solvent component may be comprised entirely of water. In other words, in examples, the solvent is water. In other examples, the solvent may include water (e.g., having a solubility parameter δₚ≈16.0 MPa^{1/2}), and one or more organic liquids with a δₚ lower than that of water. In an additional or alternative example, an aqueous composition of the present disclosure may include one or more solutes that can be modified by addition of one or more organic liquids so as to provide the composition with a target δₚ that is less than the δₚ of the original aqueous composition that does not include the one or more organic liquids.

Where the solvent contains water and one or more organic liquids, the one or more organic liquids may act to reduce the δₚ value of the solvent component to a point where the solvent system exhibits an increased ability to solubilize one or more proteins that make up microbial cell walls (e.g., extracellular proteins attached to an extracellular surface of a microbial cell wall). In some examples, it is within the scope of this disclosure that a composition of the present disclosure may be comprised of an organic liquid or a mixture of two or more organic liquids, to the exclusion of water. In an example, each of the one or more organic liquid(s) may have a δₚ less than or equal to 15.5 MPa^{1/2}, which may be capable of solvating the solute component (and other optional ingredients) without the presence or addition of water.

Thus, discussed herein, the solvent used for compositions of the present disclosure may in examples consist of, or consist essentially of, organic liquids. In other examples, the solvent may consist, or consist essentially of, water and an organic liquid having δₚ less than or equal to 15.5 MPa^{1/2}. In yet other embodiments, the solvent can consist of, or consist essentially of, water and two or more organic liquids with the resulting solvent having δₚ values less than or equal to 15.5 MPa^{1/2}. In yet other embodiments, the solvent can consist of, or consist essentially of, water.

With respect to organic liquids, preferred compounds include but are not limited to alcohols, due to their low toxicity profile and environmental friendliness. In one example, compositions of the present disclosure may in some embodiments include at least one glycol. Discussed herein, glycol refers to any class of organic compounds belonging to the alcohol family. In one example, the presence of glycol(s) may serve to assist in structuring the water included in a composition of the present disclosure, which in turn may reduce water activity of the composition. In embodiments where a particular composition includes one or more enzymes (discussed below), the one or more glycols may additionally function as enzyme stabilizing agents. In some examples, more than one glycol may be included, for example two glycols, or three glycols (or even more in some examples). Where included, the compositions of the present disclosure may include the one or more glycols at between 1-25% of the composition, for example between 1-20%, or between 1-18% or between 1-16% or between 1-14%, or between 1-12%, or between 1-10%, or between 1-8%, or between 1-6%, or between 1-4%, etc. Examples of glycols relevant to the present disclosure include but are not limited to glycerol, polyethylene glycol, and/or 1,3 propanediol. Discussed herein, glycols may also be referred to as composition stabilizers and/or may comprise at least a subset of grease removal agents as herein disclosed.

In examples, the solvent may comprise low molecular weight alcohols, including but not limited to isopropanol, ethanol, methanol, butanol, and the like. In some examples, such alcohols may comprise 1-6% of a composition of the present disclosure, more specifically from 1-5%. In other additional or alternative example the solvent may comprise acetals including but not limited to dimethoxymethane, dioxolane, and solketal (C₆H₁₂O₃). Such components may function, at least partially, as grease removal agents, and foaming control agents, and may additionally or alternatively serve as antibacterial agents, in addition to their role as solvents.

Surfactants

The compositions of the present disclosure may comprise one or more surfactants, including anionic, nonionic, zwitterionic, amphoteric and/or cationic surfactants. The surfactants can be used either alone or as compatible mixtures thereof. The total amount of surfactants in the compositions of the present disclosure ranges from 0% to 50%.

In embodiments, the total amount of surfactants include one or more nonionic surfactants and one or more anionic surfactants. The one or nonionic surfactants may be present in the laundry detergent compositions at a range of 0-25%, for example 5-25%, or 8-25%, or 10-25%, or 15-25%, etc. The one or more anionic surfactants may be present at a range of 0-30%, for example 2-30%, or 5-30%, or 10-30%, or 15-30%, or 20-30%, or 25-30%. In embodiments, one or more of the nonionic surfactants and/or one or more of the anionic surfactants may be derived from bio-based carbon (e.g. plant) sources. In embodiments, one or more of the nonionic surfactants and/or one or more of the anionic surfactants may be synthetically derived.

Discussed herein, surfactants are also referred to as “dirt lifting and removal agents.” It is herein recognized that, when appropriately selected, surfactants of the present disclosure can also promote increased osmolarity and/or tonicity of the compositions of the present disclosure. Such increased osmolarity and/or tonicity may be advantageous in terms of disrupting lipid bilayers on the exterior of microbial cells. Additionally or alternatively, surfactants (for example a polar surfactant) may increase efficacy of compositions of the present disclosure in terms of reducing or preventing microbial contamination, by increasing a rate at which the composition acts to reduce or prevent the microbial contamination (e.g., by reducing or preventing cell survival and/or proliferation). For example, one or more surfactants may contribute to microbial cell lysis by attaching to portions of cell wall proteins that are solubilized by the solvent component of compositions of the present disclosure. This attachment may be understood to prevent microbes from functioning to survive and proliferate, and in examples may additionally or alternatively act to disrupt the microbial cell membrane so as to result in cell permeation and/or leakage, thus contributing to reduced ability to survive and/or proliferate.

In embodiments, anionic surfactants may include fatty acid soap with high oleic acid and/or high linoleic acid content. Examples of such anionic surfactants can include but are not limited to Tall oil soap, sunflower oil soap, olive oil soap, oleic acid soap, and the like). In some examples, anionic surfactants comprised of high oleic acid and/or high linoleic acid content may be combined with a fatty acid soap containing a high lauric acid content, examples of which include but are not limited to coconut oil soap, palm oil soap, or laurel oil soap. It may be understood that such anionic surfactants, alone or in combination, may function to increase inhibitory capabilities of the compositions of the present disclosure against various microbial species. In some examples, the compositions of the present disclosure may include anionic surfactants comprised of high oleic acid content and/or high linoleic acid content, and anionic surfactants containing a high lauric acid content at a ratio of between 1-10:1, respectively, for example 1-5:1, or 5-10:1. In some examples, the ratio is 3:1, or 3.5:1, or 4:1.

In some embodiments, compositions of the present disclosure may include a synthetic anionic surfactant. Specifically, it may be understood that the above-mentioned anionic surfactants with high oleic acid and/or high linoleic acid content, and the anionic surfactants with high lauric acid content, may be derived from plants. Additionally or alternatively, the compositions of the present disclosure may include a synthetic anionic surfactant, a representative example of which is C14-C16 alpha olefin sulfonate. Where included, the synthetic anionic surfactant may be included at 1-20% of the laundry detergent composition. For example, between 2-18%, such as between 3-15%, such as between 5-10%, such as 7-9%, for example between 8-8.5%. In some examples, the synthetic anionic surfactant can be included at 8.2%.

In embodiments where at least the anionic surfactant with high oleic acid content is included along with the synthetic anionic surfactant, a ratio of the synthetic anionic surfactant to the anionic surfactant with high oleic acid content may be between 1:1 and 4:1, respectively, for example between 1:1 and 2:1, for example between 1:1 and 1.5:1, respectively. In some examples, the ratio may be between 1.1:1 and 1.2:1, for example 1.17:1.

In embodiments, the anionic surfactants may comprise potassium soaps of fatty acids, sodium soaps of fatty acids, or a blend of potassium and sodium soaps of fatty acids. In some embodiments, at least some fraction of the anionic surfactants included in the compositions of the present disclosure may comprise biodegradable anionic surfactants. In some examples, all of the anionic surfactants included in the compositions of the present disclosure may be bio-based (e.g., derived from carbon-based biological matter), or at least some fraction may be bio-based.

The compositions of the present disclosure may include nonionic surfactants. Nonionic surfactants can increase tonicity and reduce water activity in the compositions herein disclosed. The nonionic surfactants, where included, may comprise between 1-25% of the composition, for example between 5-25%, or between 10-25% of the composition. In some examples, the nonionic surfactants may be included between 14-25%. Bio-based or non-bio-based nonionic surfactants are within the scope of this disclosure. In some embodiments, the nonionic surfactants are bio-based and may comprise alkyl poly glucosides. Representative examples of nonionic surfactants that can be included in the detergent compositions of the present disclosure include but are not limited to coco glucoside, decyl glucoside, and lauryl glucoside. In some examples, decyl glucoside may be included at between 1-20%, for example between 5-20%, for example between 10-20%, more specifically between 12-18%, and even more specifically between 13-16%. In some examples, decyl glucoside is included in a composition at between 14-15%, or between 14.5-15%, for example 14.75%. In some examples, lauryl glucoside may be included at between 1-10%, for example between 3-10%, more specifically between 6-9%, for example between 8-9%. In some examples, lauryl glucoside may be included at 8.3%.

In some examples, a single nonionic surfactant may be included in a particular detergent composition, whereas in other examples a plurality of nonionic surfactants (e.g., a blend) may be included. In one embodiment, a detergent composition may include decyl glucoside and lauryl glucoside at a ratio between 1:1 and 4:1, for example between 1:1 and 2:1, respectively. For example, decyl glucoside and lauryl glucoside may be included at a ratio of between 1.5:1 and 2:1, respectively, or between 1.7:1 and 1.8:1, for example 1.77:1.

Polymers

In some embodiments, compositions of the present disclosure can include one or more high molecular weight polymers. Discussed herein, high molecular weight polymers refer to polymers of at least 50,000 Daltons. Such polymers include but are not limited to carboxymethyl cellulose, xantham gum, corn starch, or carboxymethyl inulin (CMI). In some examples, the compositions of the present disclosure can include a blend of high molecular weight polymers, while in other examples the compositions may include just one high molecular weight polymer. Where included, the compositions of the present disclosure may include the high molecular weight polymer(s) at 2-5%, or 2-4%, for example 3%. Discussed herein, such polymers are referred to as anti-redeposition agents. In one embodiment where the composition is a kind of laundry detergent composition, such agents may function to avoid redeposition of dirt and other contaminants onto fabric during a laundering operation.

Enzymes

The compositions of the present disclosure may include one or more enzymes. The one or more enzymes may serve as odorant and stain removal agents, however it may be understood that their function may not be limited to such agents. For example, the one or more enzymes may additionally or alternatively function as fabric rejuvenation agents. In embodiments, the one or more enzymes may be present at 1-10% of a composition, for example 1-5%, more specifically between 3-5%, for example 4%. Examples of enzymes relevant to the present disclosure include but are not limited to protease, amylase, phosphodiesterase, pectate lyase, and mannanase. In some examples, a blend of at least two enzymes, or at least three enzymes, may be included in compositions of the present disclosure. The compositions of the present disclosure may be designed in a manner (e.g., selected from the ingredients and concentrations thereof encompassed by the present disclosure) such that enzyme activity may be stabilized. For example, enzymatic activity may be maintained above preset enzymatic activity threshold(s) for a predetermined amount of time. In examples, enzymatic activity sufficient to provide desired function including but not limited to odorant and stain removal agents and/or rejuvenation agents may be maintained for at least 1 year or more.

Mineral Deposit Preventative Agents

The compositions of the present disclosure may include one or more agents that function at least partially to prevent or reduce mineral deposition onto a surface or substrate, for example a fabric. The mineral deposit preventative agents may be present in a composition at 0.1-15%, for example between 1-10%, more specifically between 2-8%. Mineral deposit preventative agents may include but are not limited to the conjugate base of an organic acid, such as citrate, lactate, glycolate, mandelate, malate, and tartrate. In some embodiments, a blend of one of the aforementioned salts may be included. Salts can be sodium, potassium, calcium, or magnesium. In a preferred embodiment, the agent is sodium citrate. In addition to functioning as mineral deposit preventative agents, these agents can contribute to increased osmolarity and inhibition of microbial metabolism. With respect to their ability to serve as mineral deposit preventative agents, they chelate metal ions and serve as a builder. In some examples, a conjugate base of an organic acid, where included, may be present in a detergent composition at 0.1-5%, for example between 1-5%, more specifically 3-5%, for example 4%.

Additionally or alternatively, a mineral deposit preventative agent may comprise one or more biodegradable chelating agents including but not limited to sodium gluconate or methylglycinediacetic acid (MDGA) sodium salt (40% Solution). Such an agent may in some examples be included to additionally function as a water softening agent. Biodegradable chelating agents such as MDGA and/or sodium gluconate may be included in detergent compositions of the present disclosure between 1-6%, for example between 1-5%, more specifically between 1-3%, for example between 2-2.5%. In some examples, the biodegradable chelating agent (or blend thereof) is included at 2.2%.

pH Control Agents

The compositions of the present disclosure may include a carbonate salt at 0.5-5%. For example a 25% solution of carbonate in water may be used to achieve a final concentration of 0.5-5% in a composition. This ingredient may serve as a pH control agent and may additionally function as a builder and/or a water softener. In one embodiment, the salts are potassium salts. In another embodiment, the salts are calcium salts. In another embodiment, the salts are sodium salts. In some embodiments, the salts are a blend of sodium and potassium salts. In some embodiments, the salts are a blend of sodium, potassium, and calcium salts. In still another embodiment, the salts are a blend of sodium and calcium salts.

In some embodiments, a hydroxide (e.g., sodium or potassium hydroxide) may be additionally or alternatively included. Where included, the hydroxide may serve to control pH and may also serve as a soap foaming agent (e.g., agent that facilitates the formation of a foam). In an example, the hydroxide (e.g., KOH) is included at 1-5%. In embodiment where both the hydroxide and the carbonate salt are included, they may in total be included in a range of 1-10%, more specifically between 1.5-8%. In a preferred embodiment, they are included at between 2-4%, such as 3%, or 3.2%. For example, the carbonate salt may be included at 1% and the KOH may be included at 2.2%, in an embodiment.

Essential Oils

In some embodiments, the compositions of the present disclosure may include an essential oil component. For example, a composition may include one or more of citral, linalool, linalyl acetate, limonene, thujone, myrcene, and the like. Where included (e.g., included at a non-zero wt. %), the essential oil component (e.g., essential oil, blends of one or more essential oils, fractionates of essential oils, etc.) may comprise 0.1-5% of a composition. In addition to imparting a particular scent to the compositions of the present disclosure, the inclusion of one or more essential oils may function to reduce water activity, and may in some examples comprise intrinsic antimicrobial properties.

### Examples

Example liquid laundry detergent compositions encompassed by the cleaning product formulations of the present disclosure were examined under a test methodology corresponding to United States Pharmacopeial Convention Chapter 51 Antimicrobial Effectiveness Testing. The testing was carried out by Microchem Laboratory (Round Rock, Tex.). Microchem Laboratory ensures consistent, reproducible results by utilizing a well-trained and educated scientific staff who work from a comprehensive system of Standard Operating Procedures, official standard methods from ASTM (American Society for Testing and Materials), AOAC, and other organizations, and custom study protocols. The laboratory provides testing services to dozens of Fortune 500 companies and has been inspected for GLP (Good Laboratory Practice) compliance by the US government. The laboratory also holds an ISO (International Organization for Standardization) 17025 accreditation and undergoes annual audit for maintenance of this accreditation.

Laboratory Qualifications Specific to USP <51>

Microchem Laboratory has performed thousands of USP <51> tests on a broad array of test substances, against method specific and non-method specific bacterial and fungal species. The laboratory may also modify the USP <51> test as needed in order to accommodate customer needs. Every USP <51> test at Microchem Laboratory is performed in a manner appropriate to the test substances submitted by the Study Sponsor, while maintaining the integrity of the method.

Study Timeline

Cultures corresponding to bacterial species, yeast species, and mold species were first initiated. Test substances were next inoculated, and evaluated at day 14 and day 28 to generate the results report.

Test Substances

Test substances included 1) LLD (liquid laundry detergent)-UP-F+C DW3-125-A (free and clear), 2) LLD-UP-Lavender DW3-125-B (lavender), 3) LLD-UP-Lemongrass DW3-125-C (lemongrass), and 4) LLD-UP-Fresh air DW3-125-D (fresh air). Test substances arrived as ready-to-use.

Test Microorganism Information

Staphylococcus aureus 6538

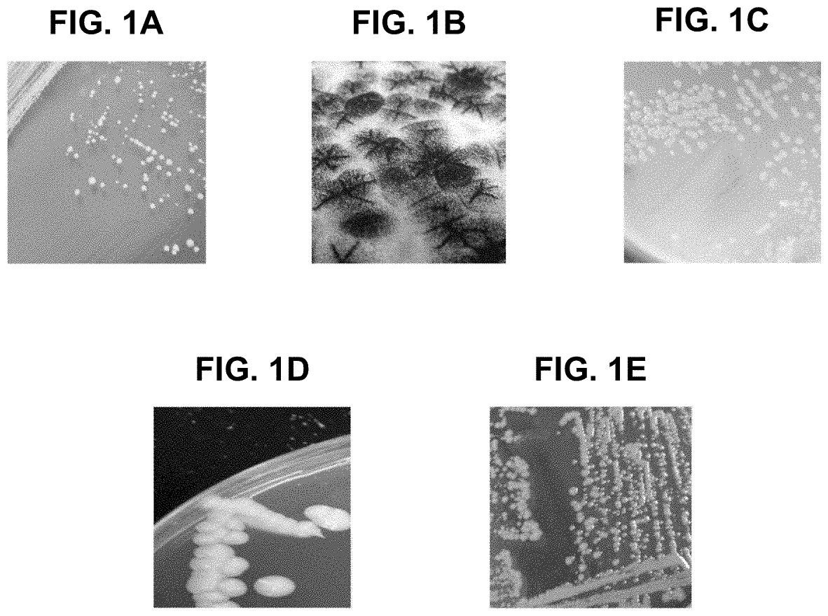

This bacterium is a Gram-positive, spherical-shaped, facultative anaerobe (FIG. 1A). Staphylococcus species are known to demonstrate resistance to antibiotics such as methicillin. S. aureus pathogenicity can range from commensal skin colonization to more severe diseases such as pneumonia and toxic shock syndrome (TSS). S. aureus is commonly used in several test methods as a model for gram positive bacteria. It can be difficult to disinfect but does demonstrate susceptibility to low level disinfectants.

Aspergillus brasiliensis 16404

This fungi (FIG. 1B) is a conidiophore, or a sexual spore generating aerobic fungus. A. brasiliensis, formerly listed as a strain of A. niger, is related to other Aspergillus species in that they produce spores which are highly resistant to chemical and environmental conditions. A. brasiliensis is commonly used as a benchmark fungus for antimicrobial fungicides and preservatives used in pharmaceutical and personal care products.

Pseudomonas aeruginosa 9027

This bacteria is a Gram-negative, rod-shaped microorganism with a single flagellum (FIG. 1C). It grows optimally under aerobic conditions, however, it can use a host of electron receptors to respire anaerobically. P. aeruginosa can be found almost anywhere in nature and it is an opportunistic pathogen. Like many other bacterial-related diseases, the ability to form resilient biofilms within human tissues under anaerobic conditions is thought to be the primary cause for pathogenicity.

Candida albicans 10231

This fungi is facultatively aerobic and can grow both as a yeast and as a filamentous fungus (FIG. 1D). Candida albicans is a commensal microorganism meaning it normally inhabits the human mouth and gastrointestinal tract but is opportunistic and can cause candidiasis or thrush. Candida albicans can survive for long periods of time without nutrients and is known to form biofilms on medical devices, therefore, disinfection to kill these fungi is very important.

Escherichia coli 8739

This bacteria is a Gram-negative, rod shaped, facultative anaerobe commonly found in the gastrointestinal tract of mammals (FIG. 1E). Although most serotypes of this microorganism are harmless there are pathogenic groups of E. coli such as enterohemorrhagic (EHEC), verocytotoxin producing (VTEC) and Shiga-like toxin producing (STEC) that can cause a multitude of illnesses. E. coli is relatively susceptible to disinfection when dried on a surface, yet it can be a challenging microorganism to mitigate in solution.

Summary of the Procedure

At a high level, the procedure involves 1) receiving the test substance(s) at the laboratory, 2) growing microorganisms in culture, 3) culture dilution per method/sponsor instructions, and determination of initial concentrations, 4) inoculation of test substances in individual aliquots, 5) incubation of inoculated substances, 6) evaluation of test substances after predetermined time, and 7) calculation of log reductions.

For the procedure, the test microorganisms were prepared by growth in liquid or on an agar culture medium. Microorganisms grown in liquid culture were centrifuged and washed prior to testing. Suspensions of test microorganisms were standardized by dilution in a buffered saline solution. Test and control substances were dispensed, in similar known volumes, to sterile vessels. Independent volumes of test and control substances were inoculated with each test microorganism, mixed, and incubated. Control substances were immediately harvested and represent the concentration present at the start of the test, or in other words, time zero. Incubated test substances were harvested at the conclusion of each contact time by chemical neutralization. The number of surviving microorganisms at the respective contact times were assessed and logarithmic reductions were calculated based on initial concentrations observed at time zero.

Criteria for Scientific Defensibility of a USP <51> Study

For Microchem laboratory to consider a USP <51> study to be scientifically defensible, the following criteria must be met:
1) The average number of viable test microorganisms recovered from the time zero samples must be approximately 1×10⁵ cells/ml or greater.
2. Ordinary consistency between replicates must be observed for the time zero samples.
3. Positive/Growth controls must demonstrate growth of appropriate test microorganism.
4. Negative/Purity controls must demonstrate no growth of test microorganism.

Passing Criteria

Criteria for antimicrobial effectiveness is determined based on the category to which a substance belongs. For Category 2 products, the criteria for bacteria is not less than 2−log 10 from the initial count at 14 days, and no increase from the 14 day count at 28 days. The criteria for yeast and mold is no increase from the initial count at 14 and 28 days. No increase is defined as not more than 0.5 log 10 higher than the previous value.

Testing Parameters
Test Substance Volume: 10 g
Control Substance: PBS (10 ml)
Replicates: Single
Culture Growth Media: Tryptic Soy Broth (Bacteria) and Potato Dextrose Agar (Yeast & Fungi)
Culture Growth Time: 18-24 hours (Bacteria), 48 hours (Yeast), 7 days (Fungi)
Plating Media: Tryptic Soy Agar (Bacteria) and Potato Dextrose Agar (Yeast & Fungi)
Inoculum Concentration: 1.0×10⁵ CFU/ml
Inoculum Volume: 0.050 ml
Observation Times: 14 and 28 Days
Volume Harvested: 0.100 g
Enumeration Plate
Incubation Temperature: 36.0° C.±1° C. (Bacteria), 30.0° C.±2° C. (Yeast and Fungi)

Control Results
Neutralization method: Verified
Media Sterility: Sterile
Growth Confirmation: Confirmed, morphology on growth media

Calculations

Log₁₀ Reduction=Log(B/A)

Where:

B=Number of viable test microorganisms in the control substances immediately after inoculation.

A=Number of viable test microorganisms in the test substances after the contact time.

Results of the Study

Substances tested included LLDs of the present disclosure without (e.g., Free and Clear, or F+C), or with (e.g., lavender, lemongrass, fresh air) various essential oils. Table 2 depicts results for the Free and Clear LLD (LLD-UP-F+C DW3-125-A) in terms of CFU/g and log₁₀ reduction at time zero, day 14, and day 28 for various test microorganisms.

TABLE 2
CFU/g and Log₁₀ Reduction Test Data for Free and Clear LLD

| | | | | P. | | A. | C. | |
|---|---|---|---|---|---|---|---|---|
| Test | Contact | Data | E. Coli | aeruginosa | S. aureus | brasiliensis | albicans | B. cepacia |
| substance | time | description | 8739 | 9027 | 6538 | 16404 | 10231 | 25416 |
| LLD-UP- | Time | CFU/g | 6.05E+05 | 3.60E+05 | 6.65E+05 | 6.45E+05 | 4.25E+05 | 4.15E+05 |
| F + C | Zero | | | | | | | |
| DW3-125- | Day 14 | CFU/g | <5.00E+01 | <5.00E+01 | <5.00E+01 | 5.10E+03 | <5.00E+01 | <5.00E+01 |
| A | | Log10 | >4.08 | >3.86 | >4.12 | 2.10 | >3.93 | >3.92 |
| | | Reduction | | | | | | |
| | Day 28 | CFU/g | <5.00E+01 | <5.00E+01 | <5.00E+01 | <5.00E+01 | <5.00E+01 | <5.00E+01 |
| | | Log10 | >4.08 | >3.86 | >4.12 | >4.11 | >3.93 | >3.92 |
| | | Reduction | | | | | | |

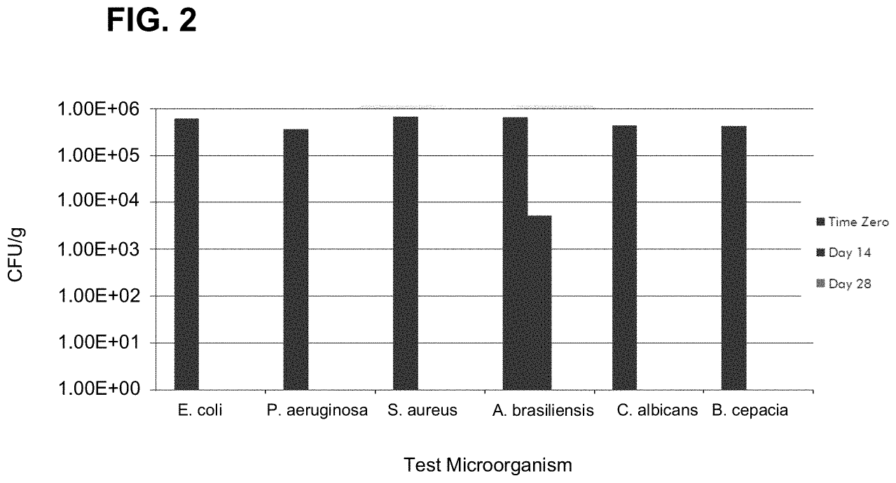

The results of Table 2 are depicted illustratively at FIG. 2. The limit of detection for the assay was 50 CFU/g. Values observed below this limit are presented as <5.00E+01 in Table 1 and FIG. 2. Table 3 below depicts results corresponding to neutralization validation (NV) counts and calculated percent recovery for the Free and Clear LLD as compared to control for various test microorganisms. The neutralization approach used was dilution of 1:100 in Dey/Engley broth.

TABLE 3
Neutralization data for Free and Clear LLD

| Test | Test | Neutralization | | Average | Percent | Neutralization |
|---|---|---|---|---|---|---|
| microorganism | substance | validation (NV) counts | | NV counts | recovery | scheme |
| E. coli | Control | 67 | 65 | 66 | N/A | 1:100 |
| ATCC 8739 | LLD-UP- | 50 | 72 | 61 | 92.42% | In |
| | F + C | | | | | Dey/Engley |
| | DW3-125-A | | | | | Broth |
| P. aeruginosa | Control | 40 | 31 | 35.5 | N/A | 1:100 |
| ATCC 9027 | LLD-UP- | 36 | 37 | 36.5 | 102.82% | In |
| | F + C | | | | | Dey/Engley |
| | DW3-125-A | | | | | Broth |
| S. aureus | Control | 52 | 65 | 58.5 | N/A | 1:100 |
| ATCC 6538 | LLD-UP- | 45 | 33 | 39 | 66.67% | In |
| | F + C | | | | | Dey/Engley |
| | DW3-125-A | | | | | Broth |
| A. brasiliensis | Control | 45 | 47 | 46 | N/A | 1:100 |
| ATCC 16404 | LLD-UP- | 38 | 37 | 37.5 | 81.52% | In |
| | F + C | | | | | Dey/Engley |
| | DW3-125-A | | | | | Broth |
| C. albicans | Control | 37 | 37 | 37 | N/A | 1:100 |
| ATCC 10231 | LLD-UP- | 38 | 36 | 37 | 100.00% | In |
| | F + C | | | | | Dey/Engley |
| | DW3-125-A | | | | | Broth |
| B. cepacia | Control | 60 | 64 | 62 | N/A | 1:100 |
| ATCC 25416 | LLD-UP- | 61 | 70 | 65.5 | 105.65% | In |
| | F + C | | | | | Dey/Engley |
| | DW3-125-A | | | | | Broth |

Table 4 below depicts results for the Lavender LLD (LLD-UP-Lavender DW3-125-B) in terms of CFU/g and log₁₀ reduction at time zero, day 14, and day 28 for various test microorganisms.

TABLE 4
CFU/g and Log₁₀ Reduction Test Data for Lavender LLD

| | | | | P. | | A. | C. | |
|---|---|---|---|---|---|---|---|---|
| Test | Contact | Data | | aeruginosa | S. aureus | brasiliensis | albicans | B. cepacia |
| substance | time | description | E. Coli | 9027 | 6538 | 16404 | 10231 | 25416 |
| LLD-UP- | Time | CFU/g | 6.05E+05 | 3.60E+05 | 6.65E+05 | 6.45E+05 | 4.25E+05 | 4.15E+05 |
| Lavender | Zero | | | | | | | |
| DW3- | Day 14 | CFU/g | <5.00E+01 | <5.00E+01 | <5.00E+01 | 1.85E+03 | <5.00E+01 | <5.00E+01 |
| 125-B | | Log10 | >4.08 | >3.86 | >4.12 | 2.54 | >3.93 | >3.92 |
| | | Reduction | | | | | | |
| | Day 28 | CFU/g | <5.00E+01 | <5.00E+01 | <5.00E+01 | <5.00E+01 | <5.00E+01 | <5.00E+01 |
| | | Log10 | >4.08 | >3.86 | >4.12 | >4.11 | >3.93 | >3.92 |
| | | Reduction | | | | | | |

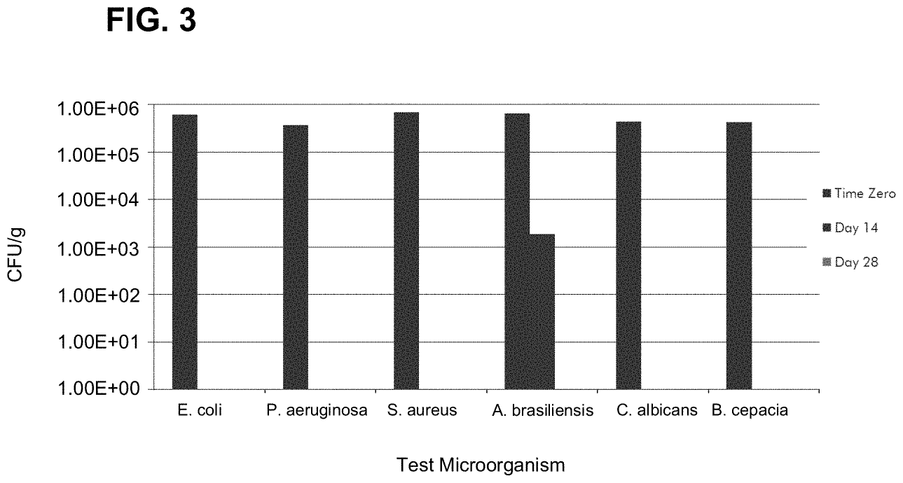

The results of Table 4 are depicted illustratively at FIG. 3. The limit of detection for the assay was 50 CFU/g. Values observed below this limit are presented as <5.00E+01 in Table 3 and FIG. 3. Table 5 below depicts results corresponding to neutralization validation (NV) counts and calculated percent recovery for the Lavender LLD as compared to control for various test microorganisms. The neutralization approach used was dilution of 1:100 in Dey/Engley broth.

TABLE 5
Neutralization data for Lavender LLP

| Test | Test | Neutralization | | Average | Percent | Neutralization |
|---|---|---|---|---|---|---|
| microorganism | substance | validation (NV) counts | | NV counts | recovery | scheme |
| E. coli | Control | 67 | 65 | 66 | N/A | 1:100 |
| ATCC 8739 | LLD-UP- | 59 | 61 | 60 | 90.91% | In |
| | Lavender | | | | | Dey/Engley |
| | DW3-125-B | | | | | Broth |
| P. aeruginosa | Control | 40 | 31 | 35.5 | N/A | 1:100 |
| ATCC 9027 | LLD-UP- | 29 | 38 | 33.5 | 94.37% | In |
| | Lavender | | | | | Dey/Engley |
| | DW3-125-B | | | | | Broth |
| S. aureus | Control | 74 | 91 | 82.5 | N/A | 1:100 |
| ATCC 6538 | LLD-UP- | 53 | 57 | 55 | 66.67% | In |
| | Lavender | | | | | Dey/Engley |
| | DW3-125-B | | | | | Broth |
| A. brasiliensis | Control | 45 | 47 | 46 | N/A | 1:100 |
| ATCC 16404 | LLD-UP- | 43 | 41 | 42 | 91.30% | In |
| | Lavender | | | | | Dey/Engley |
| | DW3-125-B | | | | | Broth |
| C. albicans | Control | 37 | 37 | 37 | N/A | 1:100 |
| ATCC 10231 | LLD-UP- | 28 | 40 | 34 | 91.89% | In |
| | Lavender | | | | | Dey/Engley |
| | DW3-125-B | | | | | Broth |
| B. cepacia | Control | 60 | 64 | 62 | N/A | 1:100 |
| ATCC 25416 | LLD-UP- | 58 | 53 | 55.5 | 89.52% | In |
| | Lavender | | | | | Dey/Engley |
| | DW3-125-B | | | | | Broth |

Table 6 below depicts results for the Lemongrass LLD (LLD-UP-Lemongrass DW3-125-C) in terms of CFU/g and log₁₀ reduction at time zero, day 14, and day 28 for various test microorganisms.

TABLE 6
CFU/g and Log₁₀ Reduction Test Data for Lemongrass LLP

| | | | | P. | | A. | C. | |
|---|---|---|---|---|---|---|---|---|
| Test | Contact | Data | | aeruginosa | S. aureus | brasiliensis | albicans | B. cepacia |
| substance | time | description | E. Coli | 9027 | 6538 | 16404 | 10231 | 25416 |
| LLD-UP- | Time | CFU/g | 6.05E+05 | 3.60E+05 | 6.65E+05 | 6.45E+05 | 4.25E+05 | 4.15E+05 |
| Lemongrass | Zero | | | | | | | |
| DW3-125-C | Day 14 | CFU/g | <5.00E+01 | <5.00E+01 | <5.00E+01 | <5.00E+01 | <5.00E+01 | <5.00E+01 |
| | | Log10 | >4.08 | >3.86 | >4.12 | >4.11 | >3.93 | >3.92 |
| | | Reduction | | | | | | |
| | Day 28 | CFU/g | <5.00E+01 | <5.00E+01 | <5.00E+01 | <5.00E+01 | <5.00E+01 | <5.00E+01 |
| | | Log10 | >4.08 | >3.86 | >4.12 | >4.11 | >3.93 | >3.92 |
| | | Reduction | | | | | | |

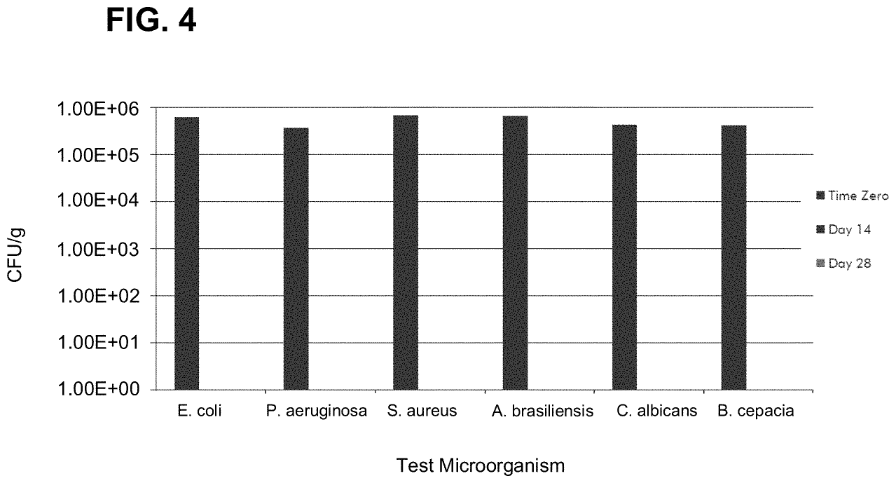

The results of Table 6 are depicted illustratively at FIG. 4. The limit of detection for the assay was 50 CFU/g. Values observed below this limit are presented as <5.00E+01 in Table 5 and FIG. 4. Table 7 below depicts results corresponding to neutralization validation (NV) counts and calculated percent recovery for the Lemongrass LLD as compared to control for various test microorganisms. The neutralization approach used was dilution of 1:100 in Dey/Engley broth.

TABLE 7
Neutralization data for Lemongrass LLP

| Test | Test | Neutralization | | Average | Percent | Neutralization |
|---|---|---|---|---|---|---|
| microorganism | substance | validation (NV) counts | | NV counts | recovery | scheme |
| E. coli | Control | 67 | 65 | 66 | N/A | 1:100 |
| ATCC 8739 | LLD-UP- | 62 | 80 | 71 | 107.58% | In |
| | Lemongrass | | | | | Dey/Engley |
| | DW3- | | | | | Broth |
| | 125-C | | | | | |
| P. aeruginosa | Control | 40 | 31 | 35.5 | N/A | 1:100 |
| ATCC 9027 | LLD-UP- | 32 | 45 | 38.5 | 108.45% | In |
| | Lemongrass | | | | | Dey/Engley |
| | DW3- | | | | | Broth |
| | 125-C | | | | | |
| S. aureus | Control | 74 | 91 | 82.5 | N/A | 1:100 |
| ATCC 6538 | LLD-UP- | 84 | 79 | 81.5 | 98.79% | In |
| | Lemongrass | | | | | Dey/Engley |
| | DW3- | | | | | Broth |
| | 125-C | | | | | |
| A. brasiliensis | Control | 45 | 47 | 46 | N/A | 1:100 |
| ATCC 16404 | LLD-UP- | 54 | 40 | 47 | 102.17% | In |
| | Lemongrass | | | | | Dey/Engley |
| | DW3- | | | | | Broth |
| | 125-C | | | | | |
| C. albicans | Control | 37 | 37 | 37 | N/A | 1:100 |
| ATCC 10231 | LLD-UP- | 23 | 35 | 29 | 78.38% | In |
| | Lemongrass | | | | | Dey/Engley |
| | DW3- | | | | | Broth |
| | 125-C | | | | | |
| B. cepacia | Control | 60 | 64 | 62 | N/A | 1:100 |
| ATCC 25416 | LLD-UP- | 52 | 47 | 49.5 | 79.84% | In |
| | Lemongrass | | | | | Dey/Engley |
| | DW3- | | | | | Broth |
| | 125-C | | | | | |

Table 8 below depicts results for the Fresh Air LLD (LLD-UP-Fresh air DW3-125-D) in terms of CFU/g and log₁₀ reduction at time zero, day 14, and day 28 for various test microorganisms.

TABLE 8
CFU/g and Log₁₀ Reduction Test Data for Fresh Air LLD

| | | | | P. | | A. | C. | |
|---|---|---|---|---|---|---|---|---|
| Test | Contact | Data | | aeruginosa | S. aureus | brasiliensis | albicans | B. cepacia |
| substance | time | description | E. Coli | 9027 | 6538 | 16404 | 10231 | 25416 |
| LLD-UP- | Time | CFU/g | 6.05E+05 | 3.60E+05 | 6.65E+05 | 6.45E+05 | 4.25E+05 | 4.15E+05 |
| Fresh air | Zero | | | | | | | |
| DW3-125-D | Day 14 | CFU/g | <5.00E+01 | <5.00E+01 | <5.00E+01 | 2.35E+03 | <5.00E+01 | <5.00E+01 |
| | | Log10 | >4.08 | >3.86 | >4.12 | 2.44 | >3.93 | >3.92 |
| | | Reduction | | | | | | |
| | Day 28 | CFU/g | <5.00E+01 | <5.00E+01 | <5.00E+01 | <5.00E+01 | <5.00E+01 | <5.00E+01 |
| | | Log10 | >4.08 | >3.86 | >4.12 | >4.11 | >3.93 | >3.92 |
| | | Reduction | | | | | | |

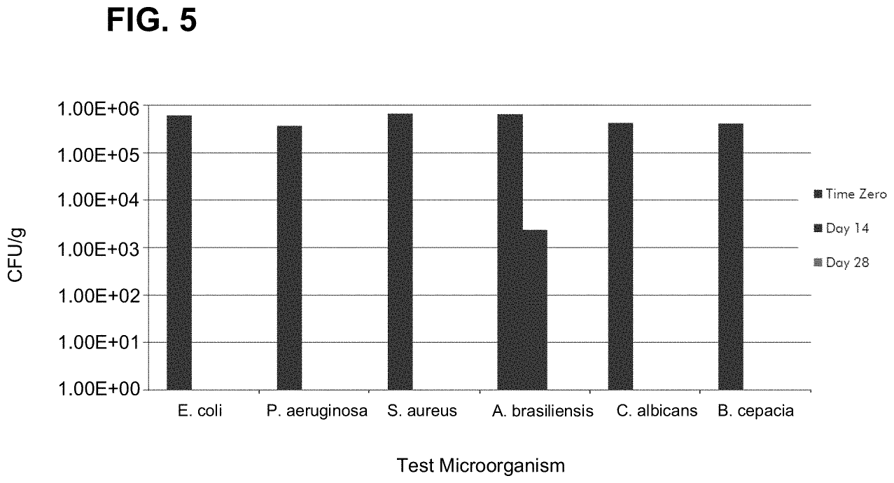

The results of Table 8 are depicted illustratively at FIG. 5. The limit of detection for the assay was 50 CFU/g. Values observed below this limit are presented as <5.00E+01 in Table 7 and FIG. 5. Table 9 below depicts results corresponding to neutralization validation (NV) counts and calculated percent recovery for the Fresh Air LLD as compared to control for various test microorganisms. The neutralization approach used was dilution of 1:100 in Dey/Engley broth.

TABLE 9
Neutralization data for Fresh Air LLD

| Test | Test | Neutralization | | Average | Percent | Neutralization |
|---|---|---|---|---|---|---|
| microorganism | substance | validation (NV) counts | | NV counts | recovery | scheme |
| E. coli | Control | 67 | 65 | 66 | N/A | 1:100 |
| ATCC 8739 | LLD-UP- | 70 | 75 | 72.5 | 109.85% | In |
| | Fresh air | | | | | Dey/Engley |
| | DW3-125-D | | | | | Broth |
| P. aeruginosa | Control | 40 | 31 | 35.5 | N/A | 1:100 |
| ATCC 9027 | LLD-UP- | 36 | 45 | 40.5 | 114.08% | In |
| | Fresh air | | | | | Dey/Engley |
| | DW3-125-D | | | | | Broth |
| S. aureus | Control | 74 | 91 | 82.5 | N/A | 1:100 |
| ATCC 6538 | LLD-UP- | 109 | 94 | 101.5 | 123.03% | In |
| | Fresh air | | | | | Dey/Engley |
| | DW3-125-D | | | | | Broth |
| A. brasiliensis | Control | 45 | 47 | 46 | N/A | 1:100 |
| ATCC 16404 | LLD-UP- | 47 | 41 | 44 | 95.65% | In |
| | Fresh air | | | | | Dey/Engley |
| | DW3-125-D | | | | | Broth |
| C. albicans | Control | 37 | 37 | 37 | N/A | 1:100 |
| ATCC 10231 | LLD-UP- | 29 | 44 | 36.5 | 98.65% | In |
| | Fresh air | | | | | Dey/Engley |
| | DW3-125-D | | | | | Broth |
| B. cepacia | Control | 60 | 64 | 62 | N/A | 1:100 |
| ATCC 25416 | LLD-UP- | 60 | 64 | 62 | 100.00% | In |
| | Fresh air | | | | | Dey/Engley |
| | DW3-125-D | | | | | Broth |

Conclusions of the Study

The product samples LLD-UP-F+C DW3-125-A (Free and Clear LLD), LLD-UP-Lavender DW3-125-B (Lavender LLD), LLD-UP-Lemongrass DW3-125-C (Lemongrass LLD), and LLD-UP-Fresh air DW3-125-D (Fresh Air LLD) were tested per Chapter USP <51>. Each product sample successfully met the passing criteria per Chapter <51> of USP NF-2009 (United States Pharmacopeia/National Formulary).

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1. A cleaning product composition, comprising:
a solvent;
one or more agents, each of the one or more agents operable to impart a particular property to the cleaning product composition; and
wherein the cleaning product composition includes a combination of a water activity of less than 0.7, an alkaline or an acidic pH, an ionic strength corresponding to a conductivity >30 mS/cm, and a high osmolarity (>0.5 osmoles/L) and tonicity capable to cause a chemical potential imbalance across a microbial cell membrane sufficient to prevent or reduce microbial cell proliferation and/or survival.

2. The composition of claim 1, wherein the solvent comprises less than 50 wt. % of the composition; and
wherein the solvent is one of water, water plus an organic liquid, or one or more organic liquids in the absence of added water.

3. The composition of claim 1, wherein the one or more agents further comprise:
one or more dirt lifting and removal agents comprising 15-50 wt. % of the composition; and
wherein the one or more dirt lifting and removal agents include at least one of decyl glucoside, lauryl glucoside, sodium olefin sulfonate, distilled tall oil fatty acid, and lauric acid.

4. The composition of claim 1, wherein the one or more agents further comprise:
one or more composition stabilizer agents comprising 0.1-15 wt. % of the composition; and
wherein the one or more composition stabilizer agents are selected from an alkali and/or alkaline-earth metal chloride compound and glycerol.

5. The composition of claim 1, wherein the one or more agents further comprise:
one or more mineral deposit preventative agents comprising 0.1-15 wt. % of the composition; and
wherein the one or more mineral deposit preventative agents are selected from conjugate base(s) of one or more organic acids and a methylglycinediacetic acid salt.

6. The composition of claim 1, wherein the one or more agents further comprise:
one or more pH control agents comprising 0.1-5 wt. % of the composition; and
wherein the one or more pH control agents are selected from sodium and/or potassium carbonate, sodium and/or potassium hydroxide, citric acid, lactic acid, glycolic acid, mandelic acid, malic acid, and tartaric acid, oleic acid, lauric acid, and tall oil fatty acids.

7. The composition of claim 1, wherein the one or more agents further comprise:
one or more de-odorant and/or stain remover agents comprising 0.1-20 wt. % of the composition; and
wherein the one or more de-odorant and/or stain remover agents further comprise one or more of protease, amylase, pectate lyase, lipase, cellulase, phosphodiesterase, and mannanase.

8. The composition of claim 1, wherein the one or more agents further comprise:
one or more grease removal agents comprising 0.1-15 wt. % of the composition; and
wherein the one or more grease removal agents comprise at least one of di isopropylidene glycerol, 1,3 propane diol, and ethanol.

9. The composition of claim 1, wherein the one or more agents further comprise:
one or more anti-redeposition agents comprising 0.1-8 wt. % of the composition; and
wherein the one or more anti-redeposition agents is a high molecular weight polymer of 50,000 Daltons or greater.

10. The composition of claim 1, wherein the composition is free of isothiazolinones, quaternary ammonium compounds, benzoates, parabens, and formaldehyde donors.

11. A self-preserving liquid laundry detergent composition, comprising:
a solvent at 20-50 wt. % of the composition;
one or more anionic surfactants comprising 1-20 wt. % of the composition;
one or more nonionic surfactants comprising 5-25 wt. % of the composition;
one or more enzymes comprising 0.1-5 wt. % of the composition;
one or more minerals comprising 0.01-5 wt. % of the composition;
conjugate base(s) of one or more organic acids comprising 0.1-5 wt. % of the composition;
one or more biodegradable polymers comprising 0.1-5 wt. % of the composition; and
wherein the composition is comprised of at least 85% bio-based carbon and is free from isothiazolinones, quaternary ammonium compounds, benzoates, parabens, and formaldehyde donors.

12. The composition of claim 11, wherein the one or more anionic surfactants include a first component with a high oleic acid and/or linoleic acid content, and a second component with a high lauric acid content; and
wherein a weight ratio of the first component to the second component is between 1:1 and 5:1, respectively.

13. The composition of claim 12, wherein the one or more anionic surfactants further comprise a third component that is a synthetic anionic surfactant; and
wherein a weight ratio of the third component to the first component is between 1:1 and 4:1, respectively.

14. The composition of claim 11, wherein the one or more nonionic surfactants include one or more alkyl poly glucosides.

15. The composition of claim 14, wherein the one or more alkyl poly glucosides include decyl glucoside and lauryl glucoside; and
wherein a weight ratio of the decyl glucoside to the lauryl glucoside is between 1.5:1 and 2:1, respectively.

16. The composition of claim 11, wherein the one or more enzymes are selected from protease, amylase, pectate lyase, phosphodiesterase, cellulase, and mannanase.

17. The composition of claim 11, wherein the conjugate base(s) of one or more organic acids are selected from citrate, lactate, glycolate, mandelate, malate, and tartrate.

18. The composition of claim 11, wherein the one or more biodegradable polymers is selected from carboxymethyl cellulose, xanthan gum, corn starch, and carboxymethylinulin.

19. The composition of claim 11, wherein the solvent is water.

20. The composition of claim 19, wherein the solvent further comprises an organic liquid.

21. A liquid laundry detergent composition comprising:
a solvent comprising less than 40 wt. % of the composition;
a plurality of anionic surfactants comprising 5-20 wt. % of the composition, the plurality of anionic surfactants including tall oil fatty acid, lauric acid, and a synthetic C14-C16 olefin sulfonate, where a weight ratio of the tall oil fatty acid to the lauric acid is between 1:1 and 4:1, and where a weight ratio of the synthetic C14-C16 olefin sulfonate to tall oil fatty acid is between 1:1 and 3:1;
a plurality of nonionic surfactants comprising 5-25 wt. % of the composition, the plurality of nonionic surfactants comprising decyl glucoside and lauryl glucoside at a weight ratio of the decyl glucoside to the lauryl glucoside between 1:1 and 4:1;
one or more carbonate salts at 0.5-5.0 wt. % of the composition;
a blend of two or more salts selected from citrate, lactate, glycolate, mandelate, malate, and tartrate, the blend comprising between 1-6 wt. % of the composition;
one or more biodegradable chelating agents at 1-6 wt. % of the composition;
one or more biodegradable polymers at 1-6 wt. % of the composition; and
a blend of two or more enzymes selected from protease, amylase,
phosphodiesterase, pectate lyase, and cellulase, the blend at 1-6 wt. % of the composition.

22. The composition of claim 21, wherein the one or more biodegradable polymers are selected from carboxymethyl cellulose, xantham gum, corn starch, and carboxymethyl inulin.

23. The composition of claim 21, wherein the one or more biological chelating agents is selected from sodium gluconate and methylglycinediacetic acid sodium salt.

24. The composition of claim 21, wherein the solvent comprises water and/or one or more of glycerol, polyethylene glycol, 1,3 propanediol, isopropanol, ethanol, methanol, butanol, dimethoxymethane, dioxolane, and Solketal.

25. The composition of claim 21, further comprising one or more of citral, linalool, linalyl acetate, limonene, thujone, and myrcene.
